(19) United States
(12) Patent Application Publication
(10) Pub. No.: US 2009/0212110 A1
(43) Pub. Date: Aug. 27, 2009

(54) Virtual barcodes

(75) Inventors: Todd O. Burger, Lexington, MA (US); Stuart Lipoff, Newton, MA (US); Matthew Hickox, Groton, MA (US)

Correspondence Address: WOLF GREENFIELD & SACKS, P.C., 600 ATLANTIC AVENUE, BOSTON, MA, 02210-2206, US

(73) Assignee: Chamelon Network Inc., Lexington, MA (US)

(21) Appl. No.: 12/283,740

(22) Filed: Sep. 15, 2008

Related U.S. Application Data
(63) Continuation of application No. 11/371,218, filed on Mar. 8, 2006, now abandoned.
(60) Provisional application No. 60/659,812, filed on Mar. 8, 2005.

(51) Int. Cl. G06K 7/10; G06K 19/06

(52) U.S. Cl. 235/462.01; 235/491

(57) ABSTRACT

In one embodiment, an apparatus comprises an electrically-controlled illumination source, and a circuit configured to control the illumination source so as cause the light source to generate at least one sequence of light pulses that mimics those a photo-detector of a bar code reader would observe from a reflected source when reading a printed bar code symbol. In another embodiment, an apparatus comprises an electronically reconfigurable, reflective display that is insensitive to a polarization of an incident illumination source, and a circuit configured to selectively configure the display to display a bar code symbol thereon.

This is a continuation of application Ser. No. 11/371,218, filed Mar. 8, 2006, which claims the benefit of U.S. Provisional Application Ser. No. 60/659,812, filed Mar. 8, 2005. Each of the foregoing applications is incorporated herein by reference in its entirety.

### BACKGROUND

Barcodes are widely used in consumer applications ranging from coupons to ID and transaction tokens such as library cards. Systems and methods for providing consumers with a portable electronic device that functions as an electronic wallet (a “Pocket Vault”) with a real time configurable token (a “Chameleon Card”) that can be removed from the Pocket Vault and will work in the installed base of conventional retail point-of-sale (POS) card readers and POS terminal devices, as well as a supporting network for such components, are described in U.S. Pat. No. 7,003,495, and the following U.S. Patent Applications: Ser. No. 10/969,811, filed Oct. 20, 2004; Ser. No. 60/512,798, filed Oct. 20, 2003; Ser. No. 60/543,075, filed Feb. 9, 2004; Ser. No. 10/392,319, filed Mar. 19, 2003; Ser. No. 60/366,098, filed Mar. 19, 2002; Ser. No. 60/379,964, filed May 13, 2002; Ser. No. 09/968,628, filed Oct. 1, 2001; Ser. No. 60/156,356, filed Sep. 28, 1999; Ser. No. 60/167,050, filed Nov. 23, 1999; Ser. No. 60/184,425, filed Feb. 23, 2000; Ser. No. 60/217,542, filed Jul. 12, 2000. The entire contents of the foregoing patent and each of the foregoing applications is incorporated herein by reference.

Certain of the above documents describe how, in some embodiments, it may be desirable to present a machine readable code, such as a bar code, on the display of the Pocket Vault or Chameleon Card. Accomplishing such an objective can be difficult, however, because of the manner in which electronic displays and bar code scanners are typically implemented.

### SUMMARY OF THE INVENTION

According to one aspect of the present invention, a method comprises using an electrically-controlled illumination source to generate at least one sequence of light pulses that mimics those a photo-detector of a bar code reader would observe from a reflected source when reading a printed bar code symbol.

According to another aspect of the invention, a method comprises using a bar code reader to read bar code information from at least one sequence of light pulses generated by an electrically-controlled illumination source.

According to another aspect of the invention, a method comprises displaying at least one bar code symbol on an electronically reconfigurable, reflective display that is insensitive to a polarization of an incident illumination source.

According to another aspect of the invention, a method comprises using a bar code reader to read bar code information from an electronically reconfigurable, reflective display that is insensitive to a polarization of an illumination source used by the bar code reader.

According to another aspect of the invention, a method comprises displaying a bar code symbol on an electronically reconfigurable, reflective display having a contrast ratio substantially in excess of 35%.

According to another aspect of the invention, a method comprises using a bar code reader to read bar code information from an electronically reconfigurable, reflective display having a contrast ratio substantially in excess of 35%.

According to another aspect of the invention, an apparatus comprises an electrically-controlled illumination source, and a circuit configured to control the illumination source so as cause the light source to generate at least one sequence of light pulses that mimics those a photo-detector of a bar code reader would observe from a reflected source when reading a printed bar code symbol.

According to another aspect of the invention, an apparatus comprises an electronically reconfigurable, reflective display that is insensitive to a polarization of an incident illumination source, and a circuit configured to selectively configure the display to display a bar code symbol thereon.

According to another aspect of the invention, an apparatus comprises an electronically reconfigurable, reflective display having a contrast ratio substantially in excess of 35%, and a circuit configured to selectively configure the display to display a bar code symbol thereon.

### BRIEF DESCRIPTION OF THE DRAWINGS

FIG. 1 shows an example of a typical bar code symbology;

FIG. 2 shows an example of a laser based moving beam bar code scanner that may be employed in accordance with various aspects of the invention;

FIG. 3 illustrates the typical operation of a bar code scanner like that shown in FIG. 2;

FIG. 4 illustrates how a bar code may be displayed on a reconfigurable display of an electronic device in accordance with some embodiments of the invention;

FIG. 5 illustrates how a bar code scanner like that shown in FIG. 2 may be used to scan a bar code displayed on a reconfigurable display of an electronic device in accordance with some embodiments of the invention; and

FIGS. 6-8 illustrate how a virtual bar code may be generated in accordance with some embodiments of the invention.

### DETAILED DESCRIPTION

To support the full virtual wallet capability it is desirable to also support bar codes on the Pocket Vault or the Chameleon Card that can be generated real-time by the Pocket Vault and/or Chameleon Card and be recognized and read by standard bar code reader devices such as bar code wands, moving beam bar code scanners, or contact scanners. Such a real-time configurable bar code may be called a Virtual Bar Code (VBC).

Although systems and techniques for creating VBC's are described herein as being employed in connection with the Pocket Vault and/or Chameleon Card described in the documents incorporated by reference above, it should be appreciated that the invention is not limited to such devices, and can be employed in any context or application where it may be desirable to present a machine-readable code, e.g., a bar code, on a display.

### Alternative Concepts

Several alternative concepts are described herein which might be used over a period of time. The basic concepts to support a VBC fall into two categories:

1) Those in which the Chameleon Card is so configured to be scanned

2) Those in which the Pocket Vault is so configured to be scanned

There are two basic technologies that can be used on either the Chameleon Card or Pocket Vault.

A) An electronic display that creates a graphic pattern on the display that is visible to the bar code reader and emulates a printed bar code.

B) An electronically modulated emissive light source that is so on-off modulated that the photosensor in the bar code reader, sees an electronic signal equivalent to what the sensor would see from the reflected light from its own internal light source.

### Option A—Electronic Display

With regard to option A), electronic display. A typical LCD display is capable of displaying modern barcode symbologies with contrast ratios on the order of 35%. A high quality bar code printed in dark black ink on white paper can provide contrast ratios well in excess of 95% and approaching 100%. In many cases however, a standard bar code wand or contact scanner can read such an LCD display with no problem although some bar code readers do require contrast ratios that are greater than 35%. However many moving beam bar code scanners employ a linear polarized laser diode. Since a typical LCD display consists of liquid crystal fluid between two cross linear polarized filters, it is a random event that would allow the light from the scanner laser diode to have a polarization that is aligned with the front filter of the LCD display. If the light is not so aligned the LCD display will not be scannable by such a moving beam scanner.

One approach is to display the bar code with multiple orientations on the screen (e.g. some with vertical bars and others with horizontal bars). In this case if the laser scanner will not read one orientation it will read the other. Another approach is to convert the linear polarizer beam from the laser to a polarization that will work regardless of the bar code display orientation. One approach to so this is to place a quarter wave retardation film (also known as a quarter wave plate) on top of the LCD display at a 45 degree angle to the linear polarization of the laser. This converts the laser linear polarization to a circular polarization that will pass through the top filter of the LCD display.

Another is to use a non-conventional reflective display that does not have a polarizer. Typically such reflective displays employ bistable technology. One such display technology is that being advanced by eInk of Cambridge, Ma and commonly known as electronic paper. Another such display is a bistable LCD display without polarizers such as that being advanced by Kent Displays of Kent, Ohio and employs cholesteric liquid crystal material. Both of these reflective display examples can produce high contrast ratio images in excess of 90% approaching that of dark black ink on white paper. These displays therefore provide two benefits making them suitable for reading by a large variety of bar code readers: 1) The absence of polarizers facilitates operating with moving linear polarized beam scanners and 2) The high contrast ratio supports a wider variety of scanners that can not operate at the 35% contrast ratio of conventional LCDs.

### Option B—Electronic Modulated Light Source

In this case, a source such as, but not limited to, a high radiance LED of a RED color (i.e. wavelength) the same as or near to the color of a typical bar code wand LED or moving beam RED laser. The source is then modulated on/off by an electronic circuit such as the serial output of a microcomputer integrated circuit. The modulation is chosen to emulate the electronic signal the photodetector in the bar code reader would receive if it received the reflected light from a printed bar code. For example the white portion of the printed bar code would correspond to the LED being on while a black bar in the bar code symbol would correspond to the LED being off.

Since bar code readers have different scan rates, to create a reliable read the LED would be modulated at several different scan rates. The exact rate is not critical and perhaps rates from a few scans per second up to several hundred scans per second should cover the range. Testing has been done at about the 35 scan per second rate to demonstrate the concept works.

Since a bar code wand reader is just a point source, a single LED held close to the bar code wander reader will work without any need to scan. For a moving beam bar code reader or contact reader, the scanner covers a linear field of view of at least the typical two inches of the length of a bar code. In such a case, the scanner needs to be held at a distance from a single LED where it can see the light from the LED across the entire field of view of the scan.

To increase the field of view, multiple LEDs in a line can be used. It would also be possible to use optical means such as cylindrical lens (e.g. molded plastic) and/or light pipes (e.g. polycarbonate rods) to extend the LED light.

To provide comfort to the consumer user of the Pocket Vault and also to the retail clerk, the main LCD screen of the Pocket Vault could provide a visible display of the bar code symbology along the edge of the main LCD screen (e.g., top, bottom, left or right) that is nearest to the LED.

As was previously explained, the electronic wallet application may be designed to support compatible interfacing to magnetic stripe point of sale (POS) infrastructure. Since one goal of the electronic wallet is to support as many of items and media that one may carry in the wallet, additional innovative concepts were developed to support media that carry bar codes in addition to, or instead of, magnetic stripes. Examples of media likely to be included in a wallet that carry bar codes include library cards, access control/ID cards, and discount coupons.

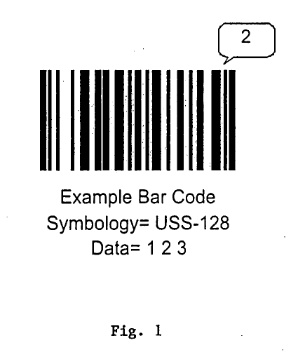

Bar code symbologies are well standardized from a finite set of codes so the electronic wallet technology is designed not just to support variable coding of the content but also to support the variety of symbologies likely to be on wallet media. An example of a two dimensional (also known as linear) bar code is shown in FIG. 1. As shown, the bar code symbology 2 is based on the USS-128 symbology. The data coded on example bar code 2 is the three digits “1 2 3.” Note that this bar code symbology comprises black and white stripes of a mix of narrow and wide stripes. For the example symbology 2, the width of both the black and white stripes is significant.

There are a variety of bar code readers designed to read bar codes of the type of example symbology 2. Since the POS environment in which the bar code will be read can not be know in advance, the electronic wallet support of bar codes may be designed so that it is able to work with most all POS bar code reader technology. Bar code readers typically fall into three general categories: manually scan bar code wands, contact self scanning CCD image array readers, and non-contact moving beam self scan readers. All three types provide a source of illumination for reading the bar code and include a variety of photodetector means to sense the reflected light from the bar code. Variations in bar code readers include the wavelength of the incident illumination light, the scan rate, the sensitivity of the photodetector, the range of contrast ratios over which the reader operates, and the ability of the reader to accommodate departures from ideal and still render an accurate read. According to one aspect of the invention, a display that can work properly with a variety of bar code readers may be designed to take into account that some readers employ linear polarized illumination and that there is a wide variation in the scan rates between different readers.

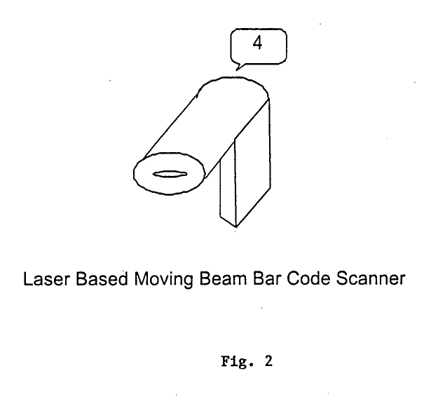

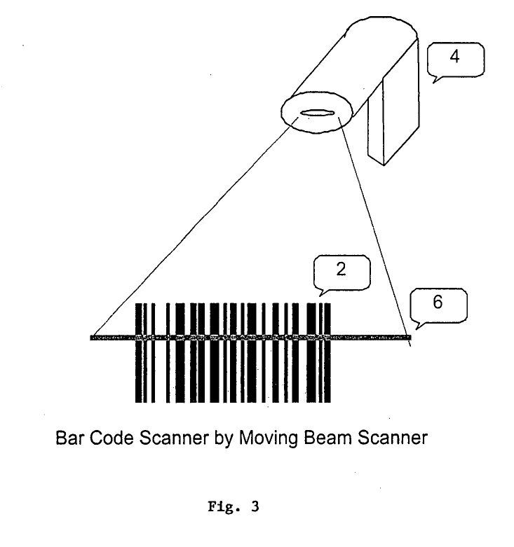

FIG. 2 shows a typical configuration for a hand held moving beam bar code scanner 4. In a typical such device a semiconductor linear polarized laser diode is scanned in a linear fashion using a moving mirror and tracking optics focuses reflected light from the bar code upon a photodetector in the scanner. As shown in FIG. 3 the scanner 4 produces a beam that appears as a straight line 6 that the operator aligns over the bar code 6 in order to effect a reading of the bar code.

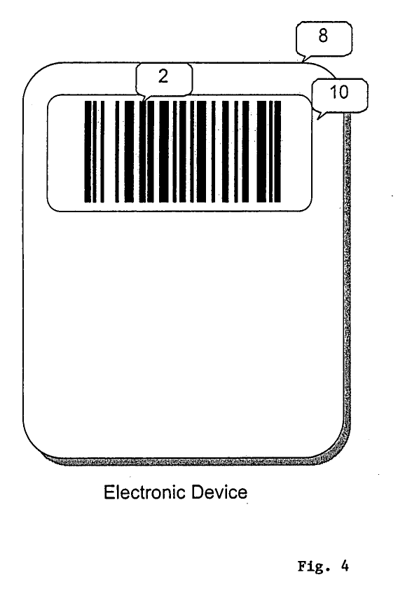

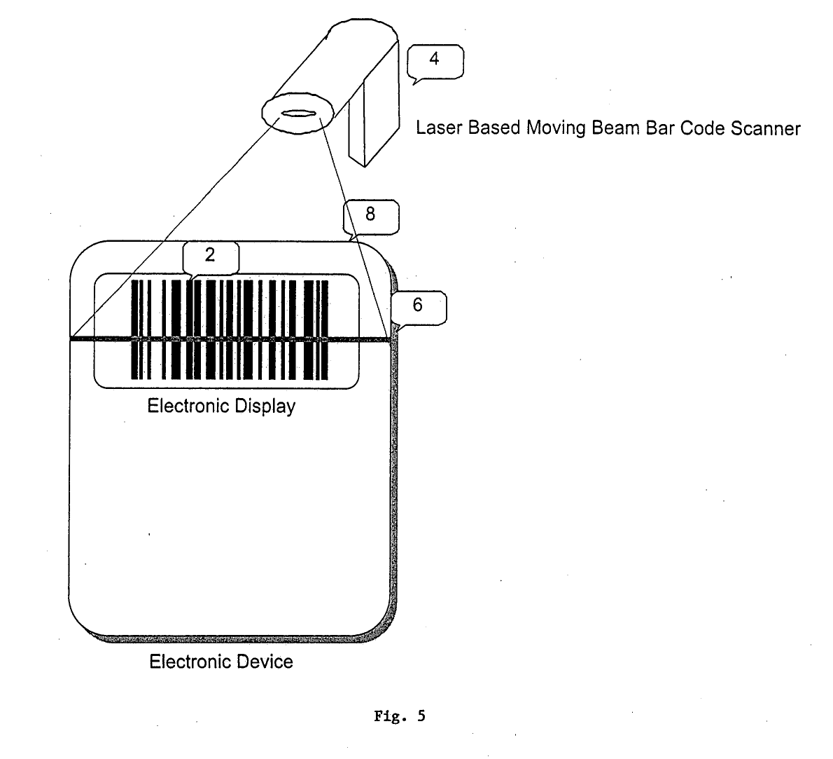

A number of alternative means may be used to emulate the bar code 2 such that the electronic wallet can present any one of many bar code symbologies and any one of many data sets encoded with the particular symbology. The first alternative means employs an electronic device such as the electronic wallet 8 shown in FIG. 4. As shown, the electronic device 8 may include an electronic display 10 that is capable of being controlled to produce an image of the bar code in the desired symbology with the desired coded information 2. Under this general alternative in FIG. 5 there are a number of possible implementations of a suitable display. Since wand and CCD type bar code readers generally employ non-polarized light most any high quality reflective display such as TN LCD will be suitable. However moving beam scanners 4 typically employ polarized light and since a conventional TN LCD display has crossed polarizing layers in the TN cell, there is a chance the random orientation of the LCD polarizers will block the linear polarized source and no reading of the bar code will be possible. Techniques to ensure a consistent read with a moving beam linear polarized scanner 4 include:
Drawing multiple bar codes 2 on the screen 10 in multiple orientations. For example with the bars running vertical as shown in FIG. 4 but with a second rendition of the bar code with the bars running horizontal. In that way at least one of the bar codes can be read with a linear polarized source.
A second approach is to apply a quarter wave retardation filter on top of the conventional TN LCD display oriented at a 45 degree angle to the top LCD polarizer so that the linear illumination from the scanner 4 will be transformed from linear polarization to circular polarization and therefore not dependent upon the orientation of the scanner beam.
A third approach is to employ an alternative reflective display to a LCD with polarizers. There are several bistable displays that would be suitable such as those produced by eInk of Cambridge, Mass. and the LCD displays of Kent Displays of Kent, Ohio. In both cases these electronic displays render images that can be scanned with polarized light and are orientation insensitive. Such devices are capable of achieving contrast ratios substantially in excess of contrast ratios of 30-35% that can be achieved by LCD displays with polarizers.

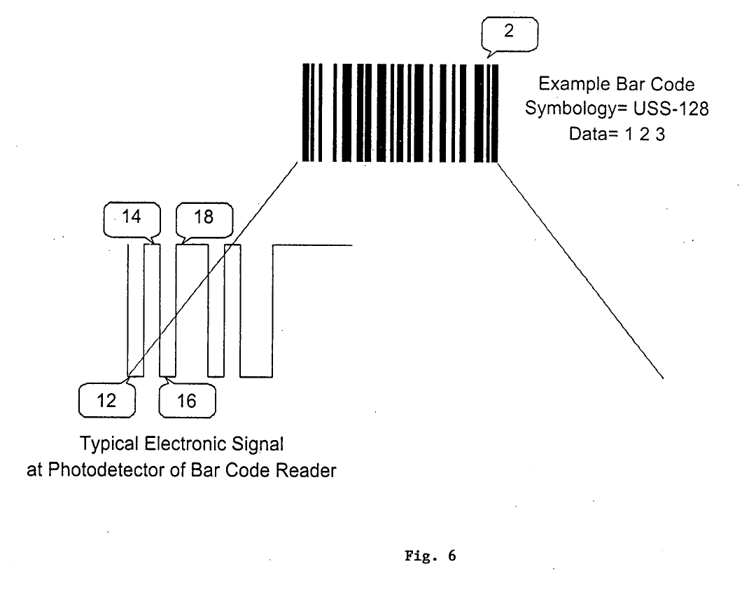

In an alternative embodiment, no display at all is required, and instead a “virtual bar code” may be generated that the scanner 4 senses just as though it was viewing a physical printed bar code 2. An example of this embodiment is explained with reference to FIG. 6. As shown, the bar code example symbol 2 comprises black and white lines. When the symbol 2 is scanned the photodetector within any of the scanner types generates an electrical signal consisting of varying positive and negative going electrical signals such as shown, for example, in pulses 12, 14, 16, and 18. In this example a negative going pulse represents a white area of the bar code symbol while a positive going pulse represents a black area of the bar code symbol. As will be apparent to one skilled in the art, however, the representation can be reversed as well.

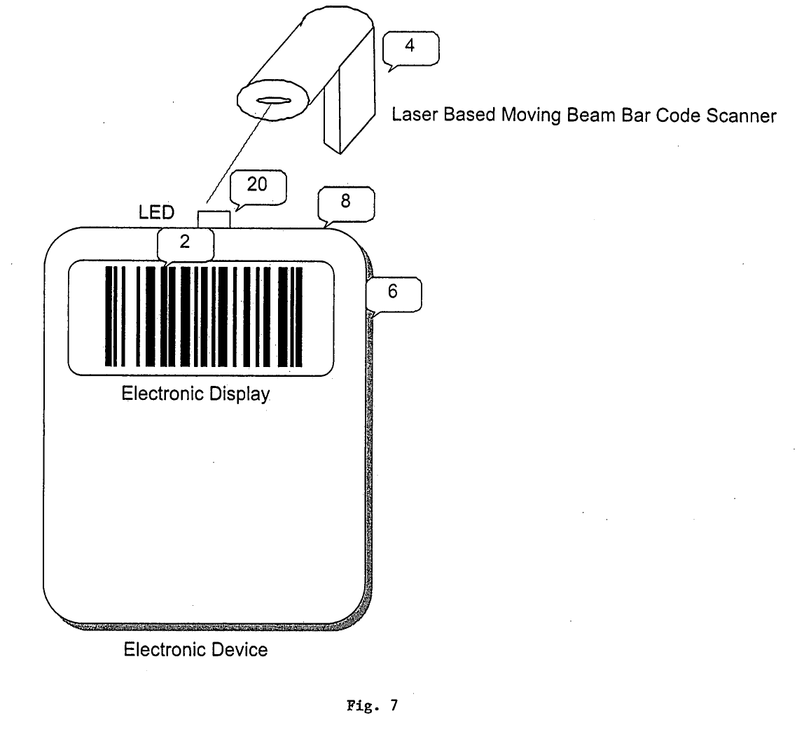

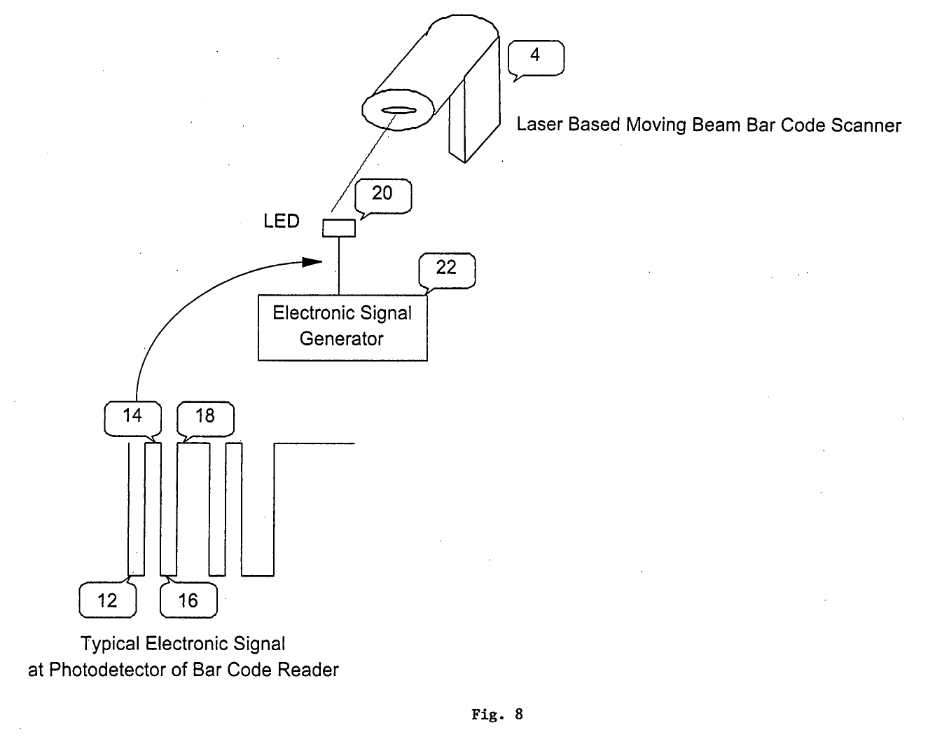

The virtual bar code invention does not rely upon a display on the electronic device but instead, as shown in FIG. 7, the scanner 4 may be pointed to an emissive light source 20 mounted on the electronic device 6. A typical emissive source could be an LED or set of LEDs in the visible red and near infrared range of illumination wavelengths typically employed in bar code readers. This configuration in FIG. 7 may operate as shown in FIG. 8 to produce an electrical signal via an electronic signal generator 22 that modulates the current through the light source 20 to produce pulses of light that emulate the reflected light the scanner would see if it were scanning a physical printed bar code. The signal created by generator 22 is the same pulses 12, 14, 16, 18 shown in FIG. 6.

Although it is not required to have a display 10 on the electronic device 8, it may be desirable to present an image of a bar code upon the display for comfort of the human operator of the device 8.

So that the scanner 4 can be assured to receive energy from the modulated light source 20 without requiring precision alignment, it may be desirable to spread, or diffuse, the light source 20 so it does not appear as a single point. Means to diffuse the light may, for example, include multiple light sources such as a linear series of LEDs that are all modulated with the same signal 22. Other alternatives may include light pipes such a high index of reflection polycarbonate plastics, perhaps in combination with cylindrical or spherical lens as well.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1-31. (canceled)

32. A method, comprising a step of:
using an electrically-controlled illumination source to generate at least one sequence of light pulses that mimics the reflected radiation a photo-detector of a bar code reader would observe when a radiation source of the bar code reader projected incident radiation on a printed bar code symbol comprising a mix of narrow and wide stripes that represent particular data.

33. The method of claim 32, further comprising steps of:
controlling the illumination source to generate at least one sequence of light pulses that mimics the reflected radiation a photo-detector of a bar code reader would observe when a radiation source of the bar code reader projected incident radiation on a printed bar code symbol having a first symbology; and
controlling the illumination source to generate at least one sequence of light pulses that mimics the reflected radiation a photo-detector of a bar code reader would observe when a radiation source of the bar code reader projected incident radiation on a printed bar code symbol having a second symbology.

34. The method of claim 32, further comprising steps of:
controlling the illumination source to generate at least one sequence of light pulses that mimics the reflected radiation a photo-detector of a bar code reader would observe when a radiation source of the bar code reader projected incident radiation on a first printed bar code symbol; and
controlling the illumination source to generate at least one sequence of light pulses that mimics the reflected radiation a photo-detector of a bar code reader would observe when a radiation source of the bar code reader projected incident radiation on a second printed bar code symbol, which is different from the first printed bar code symbol.

35. The method of claim 32, her comprising a step of:
controlling the illumination source so that a repetition rate of the at least one sequence of light pulses is different at different times.

36. A method, comprising a step of:
using a bar code reader to read bar code information from at least one sequence of light pulses that is generated by an electrically-controlled illumination source and is not reflected from a printed bar code symbol.

37. A method, comprising a step of:
displaying at least one bar code symbol on an electronically reconfigurable, reflective display that is insensitive to a polarization of an incident illumination source and is free of polarizers.

38. The method of claim 37, wherein the step of displaying the at least one bar code comprises displaying bar codes symbols using at least first and second different symbologies at different times.

39. The method of claim 37, wherein the step of displaying the at least one bar code symbol comprises displaying at least first and second bar codes symbols at different times.

40. An apparatus, comprising:
an electrically-controlled illumination source; and
a circuit configured to control the illumination source so as cause the light source to generate at least one sequence of light pulses that mimics the reflected radiation a photo-detector of a bar code reader would observe when a radiation source of the bar code reader projected incident radiation on a printed bar code symbol comprising a mix of narrow and wide stripes that represent particular data.

41. The apparatus of claim 40, wherein the circuit is further configured to control the illumination source so as to generate at least one sequence of light pulses that mimics the reflected radiation a photo-detector of a bar code reader would observe when a radiation source of the bar code reader projected incident radiation on a printed bar code symbol having a first symbology, and to further control the illumination source so as to generate at least one sequence of light pulses that mimics the reflected radiation a photo-detector of a bar code reader would observe when a radiation source of the bar code reader projected incident radiation on a printed bar code symbol having a second symbology.

42. The apparatus of claim 40, wherein the circuit is further configured to control the illumination source so as to generate at least one sequence of light pulses that mimics the reflected radiation a photo-detector of a bar code reader would observe when a radiation source of the bar code reader projected incident radiation on a first printed bar code symbol, and to further control the illumination source so as to generate at least one sequence of light pulses that mimics the reflected radiation a photo-detector of a bar code reader would observe when a radiation source of the bar code reader projected incident radiation on a second printed bar code symbol, which is different from the first printed bar code symbol.

43. The method of claim 40, wherein the circuit is further configured to control the illumination source so that a repetition rate of the at least one sequence of light pulses is different at different times.

44. An apparatus, comprising:
an electronically reconfigurable, reflective display that is insensitive to a polarization of an incident illumination source and is free of polarizers; and
a circuit configured to selectively configure the display to display a bar code symbol thereon.

45. The apparatus of claim 44, wherein circuit is further configured to configure the display to display bar codes symbols using at least first and second different symbologies at different times.

46. The apparatus of claim 44, wherein circuit is further configured to configure the display to display at least first and second bar codes symbols at different times.
